(19) United States
(12) Patent Application Publication
(10) Pub. No.: US 2026/0340396 A1
(43) Pub. Date: Oct. 29, 2026

(54) SYNTHETIC DATA GENERATION FOR MULTI-AGENT AI APPLICATIONS

(71) Applicant: Cisco Technology, Inc., San Jose, CA (US)

(72) Inventors: Andrea Morandi, Greenbrae, CA (US); Saurabh Gupta, Bellevue, WA (US); Mahesh Viswanathan, White Plains, NY (US)

(73) Assignee: Cisco Technology, Inc., San Jose, CA (US)

(21) Appl. No.: 19/191,219

(22) Filed: Apr. 28, 2025

(51) Int. Cl. G06N 3/0895; G06F 16/215

(52) U.S. Cl. CPC G06N 3/0895; G06F 16/215

(57) ABSTRACT

In one implementation, a device that executes a first agent obtains a conversation example for use by the first agent. The first agent initiates, based on the conversation example, a conversation with one or more artificial intelligence agents. The first agent records the conversation. The device provides the conversation as synthetic data to train or test an artificial intelligence model.

### TECHNICAL FIELD

The present disclosure relates generally to artificial intelligence and, more particularly, to synthetic data generation for multi-agent artificial intelligence (AI) applications.

### BACKGROUND

The recent breakthroughs in artificial intelligence (AI) such as large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

Evaluating the performance of an agentic system with multiple AI agents, though, remains challenging. This is because organizations face significant hurdles due to the lack of available and high-quality data, high costs associated with data collection, and privacy concerns when using sensitive data. These issues hinder the effective evaluation and optimization of AI agents, leading to inefficiencies and potential biases.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for synthetic data generation for multi-agent AI applications; and

FIG. 6 illustrates an example simplified procedure for generating synthetic data for multi-agent AI applications, in accordance with one or more implementations described herein.

### DESCRIPTION OF EXAMPLE IMPLEMENTATIONS

### Overview

According to one or more implementations of the disclosure, a device that executes a first agent obtains a conversation example for use by the first agent. The first agent initiates, based on the conversation example, a conversation with one or more artificial intelligence agents. The first agent records the conversation. The device provides the conversation as synthetic data to train or test an artificial intelligence model. Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

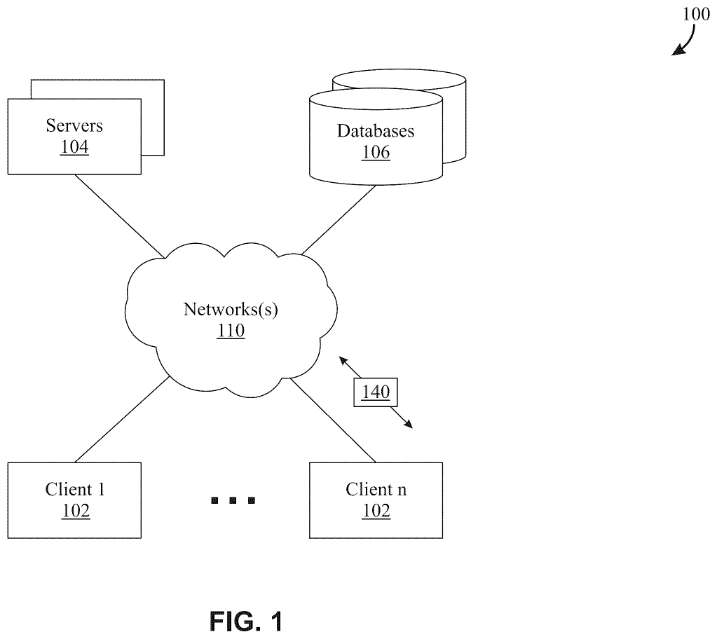

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

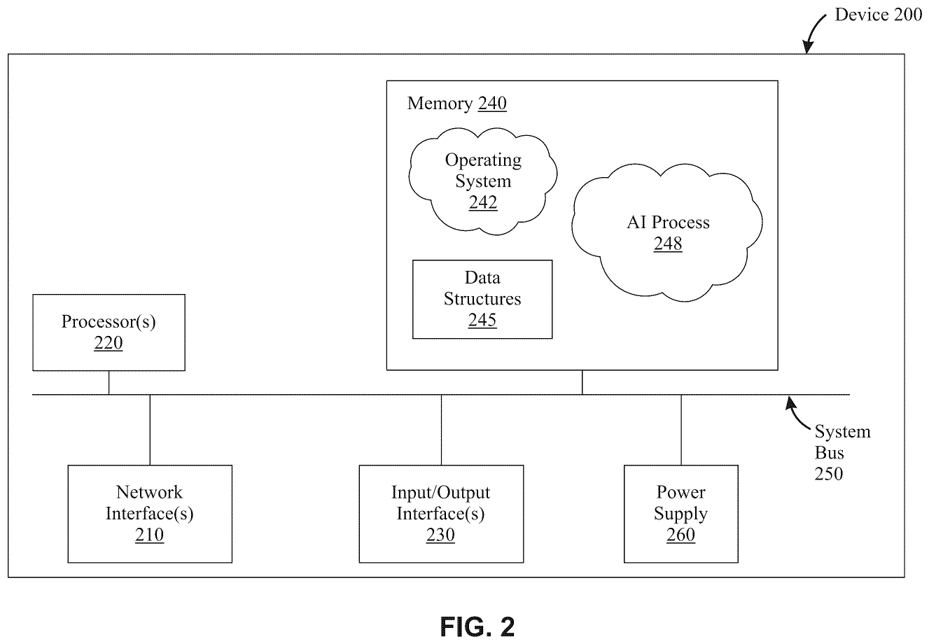

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

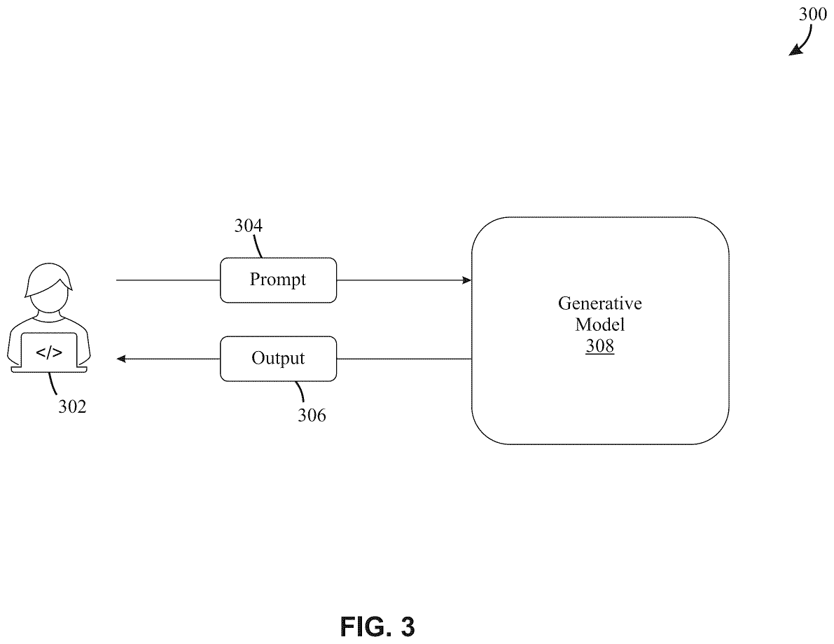

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

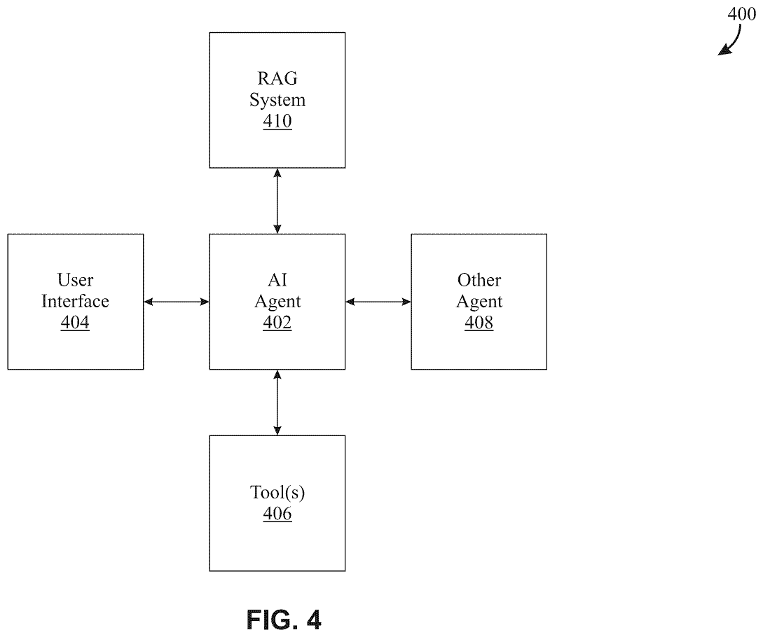

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, evaluating the performance of an agentic system with multiple AI agents, though, remains challenging. This is because organizations face significant hurdles due to the lack of available and high-quality data, high costs associated with data collection, and privacy concerns when using sensitive data. These issues hinder the effective evaluation and optimization of AI agents, leading to inefficiencies and potential biases.

### ——Synthetic Data Generation for Multi-Agent AI Applications——

The techniques herein allow for the creation of ground-truth datasets and the generation of synthetic question-answer pairs or multi-turn conversations for purposes of evaluating the efficacy of an agentic system. This approach not only ensures the availability of high-quality data but also significantly reduces costs and mitigates privacy risks.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device that executes a first agent obtains a conversation example for use by the first agent. The first agent initiates, based on the conversation example, a conversation with one or more artificial intelligence agents. The first agent records the conversation. The device provides the conversation as synthetic data to train or test an artificial intelligence model.

Operationally, the techniques herein introduce a synthetic data generation framework that creates ground-truth datasets, e.g., from seed examples or from unstructured data, such as logs, and generating synthetic question-answer pairs or multi-turn conversations. This approach not only ensures the availability of high-quality data but also significantly reduces costs and mitigates privacy risks.

By leveraging AI agents (e.g., LLM-based agents) to generate and filter synthetic data, this framework enhances the accuracy and relevance of evaluations, supports continuous learning, and optimizes agent performance through dynamic simulations and iterative improvements. This transformation enables organizations to conduct thorough and cost-effective evaluations, ultimately leading to more reliable and efficient multi-agent AI applications.

The unique ability to generate synthetic data can significantly enhance the evaluation of AI agents by addressing several key challenges such as a lack of available data, low data quality, and privacy, among others.

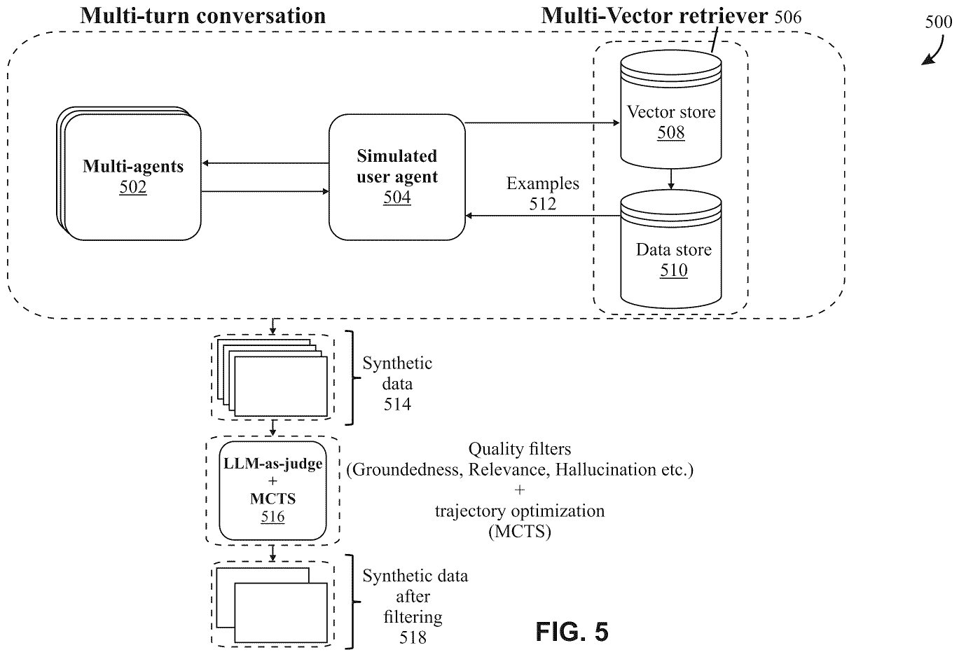

FIG. 5 illustrates an example architecture 500 for synthetic data generation for multi-agent AI applications, according to various implementations. In general, the framework of architecture 500 seamlessly implements the above abilities as follows:

Ground Truth Dataset Creation: architecture 500 is configured to generate a synthetically created dataset that may comprise question-answer pairs or even multi-turn conversations from unstructured data such as logs. To do so, architecture 500 first builds a synthetic dataset of questions and associated contexts, and, thus, answers. The approach is to get elements from a knowledge base and then ask an LLM or other suitable AI model to generate questions based on these documents. This dataset is finally used as ground truth to assess the accuracy of multi-agent systems (e.g., its accuracy during query-answer exchanges).

In some implementations, architecture 500 may create multi-turn conversations via two agents that mimic conversations between a human user and a bot, as well as complex multi-hop agent trajectories (e.g., all of the steps and calls to tools that an agent took).

Quality Filters: Additional agents in architecture 500 may act as quality filters, e.g., to ensure that the generated question-answer pairs meet specific criteria and are free from flaws. In some implementations, architecture 500 may do so by leveraging one or more critique agents that will rate each question on criterial such as any or all of the following: groundedness (e.g., whether the question be answered from the given context), relevance (e.g., whether the question is relevant to users), standalone characteristics (e.g., whether the question is understandable free of any context for someone with domain knowledge, Internet access, etc.).

Continuous Learning Engines: By generating synthetic data via LLM or other AI agents and updating strategies (e.g., multi-agent trajectories) based on collected metrics, architecture 500 supports continuous learning. This dynamic learning process ensures that the agents can adapt to new scenarios and improve their decision-making capabilities over time. To infer the optimal task performance (i.e., the ‘optimal’ agent trajectory), architecture 500 may use any suitable optimization approach such as Language Agent Tree Search (LATS) that combines reflection/evaluation and search (e.g., Monte-Carlo trees search) to infer the optimal task performance/agent trajectory.

As shown in FIG. 5, architecture 500 be operable to build a synthetic dataset of questions, associated contexts and, thus, answers. To do so, architecture 500 may ask multi-agents 502 to use their respective AI model(s) to generate synthetic data 514 in the form of questions that are based on input documents or other information. To ensure the quality of synthetic data 514, one or more filter agents 516 may use their own AI model(s) to filter synthetic data 514 into a post-filtered synthetic dataset 518. As noted above, such rubrics may include the groundedness, relevance, etc. of the synthetically generated questions in synthetic data 514.

In addition, one or more filter agents 516 may also select questions from synthetic data 514 for inclusion in post-filtered synthetic dataset 518 in an attempt to perform trajectory optimization of the agentic system. To do so, the one or more filter agents 516 may leverage ReST meets ReAct: Self-Improvement for Multi-Step Reasoning LLM Agent and optimize for task performance (i.e., the optimal agent trajectory) using an approach such as MCTS. As an enhancement, a multi-vector retriever 506 may also provide relevant examples to the agent for contextual few shot learning, where the agent is provided with a small number of relevant examples within the prompt to help it understand the task and generate appropriate responses.

According to various implementations, architecture 500 may create multi-turn conversations through the use of two categories of agents that mimic conversations between a human user and a bot. For instance, as shown, architecture 500 may include a simulated user agent 504 configured to act as a synthetic user that interacts with multi-agents 502.

Architecture 500 may also include multi-vector retriever 506 that stores examples 512 for use by simulated user agent 504 to use when interacting with multi-agents 502. For instance, multi-vector retriever 506 may be designed to improve retrieval-augmented generation (RAG) of simulated user agent 504 by separating the documents used for answer synthesis for those used for retrieval. Here, multi-vector retriever 506 may include a vector store 508 that includes vectorized information, allowing simulated user agent 504 to perform multi-vector searching based on its interactions with multi-agents 502 (e.g., by searching for vector representations of examples 512 and their associated data. In some implementations, multi-vector retriever 506 may also include a data store 510 that stores the examples 512 as raw data (e.g., the actual text, as opposed to vector embeddings).

In some implementations, architecture 500 may also use a human-in-the-loop mechanism to identify potential issues and suggest corrective actions, such as re-sampling or re-weighting data, diversifying quality filters, and/or implementing robust benchmarking and validation strategies. Implementing an iterative process where synthetic data generation and evaluation are continuously refined based on feedback from both automated systems and human evaluators ensures that the synthetic data remains diverse, representative, and high-quality, thereby enhancing the reliability and effectiveness of multi-agent AI applications.

To illustrate this approach, consider the following use case of Text-to-SQL parsing. To demonstrate the efficacy of architecture 500, the synthetic_text_to_sql dataset was used to generate the synthetic data. This dataset comprises a rich (~105 samples) dataset of high-quality synthetic Text-to-SQL samples.

To assess the performance of the techniques herein, the BIRD development dataset was used. This benchmark dataset tests SQL queries of varying difficulties: simple, moderate, and challenging. More specifically, the BIRD development dataset includes 1,534 Text-to-SQL pairs and assesses two evaluation metrics:
Execution Accuracy (EX): Measures whether the generated SQL query matches the gold value.
Valid Efficiency Score (VES): Assesses both the accuracy (EX) and efficiency of the generated SQL queries.

Table 1 below shows the quality of Text-to-SQL pairs generated via: i.) a fine-tuned CodeLlama model; ii.) standalone GPT-40; and iii.) and via the synthetic data generation framework introduced herein.

TABLE 1

| Model | EX(%) | VES(%) |
|---|---|---|
| Fine-Tuned CodeLlama | 24.58 | 25.61 |
| GPT-4o | 46.09 | 47.83 |
| Synthetic Generation Approach Herein | 47.39 | 53.09 |

Note that the quality of code generated using the techniques herein consistently surpasses that of GPT-40 (standalone LLM) and fine-tuned CodeLlama. This underscores the effectiveness the techniques in improving the quality of the generated code.

In summary, the techniques herein afford the following benefits:
1. Synthetic Data Generation: the techniques herein provide ability to generate synthetic datasets from unstructured data sources, such as logs, to create high-quality data, such as question-answer pairs and multi-turn conversations for evaluating agentic systems.
2. Relevant example(s): these examples stem from the multi-vector retriever and are used for contextual few-shot learning, where the agent is provided with a small number of relevant examples, such as tens to hundreds of question-answer pairs or unstructured data, within the prompt to help it understand the task and generate appropriate responses.
3. Quality Filtering: the techniques herein also propose the use of additional AI agents to act as quality filters, ensuring that the generated data meets specific criteria such as groundedness, relevance, etc.
4. Optimization of Trajectories: in some implementations, the techniques herein may also function to optimize the trajectories of the multi-agents, such as through the use of Monte-Carlo Tree Search (MCTS), enhancing the performance and accuracy of the AI agents. This dynamic learning process ensures that the agents can adapt to new scenarios and improve their decision-making capabilities over time, thus supporting continuous learning.
5. Cost Savings: the techniques herein may also significantly reduce the costs associated with data collection and evaluation by generating synthetic datasets, thereby eliminating the need for expensive and time-consuming data collection processes and mitigating privacy concerns related to the use of sensitive data.
6. A Human-in-the-loop Mechanism: in some implementations, the techniques herein may also use a human-in-the-loop mechanism to identify potential issues and suggest corrective actions, to ensure that the synthetic data remains diverse, representative, and high-quality, thereby enhancing the reliability and effectiveness of multi-agent AI applications.

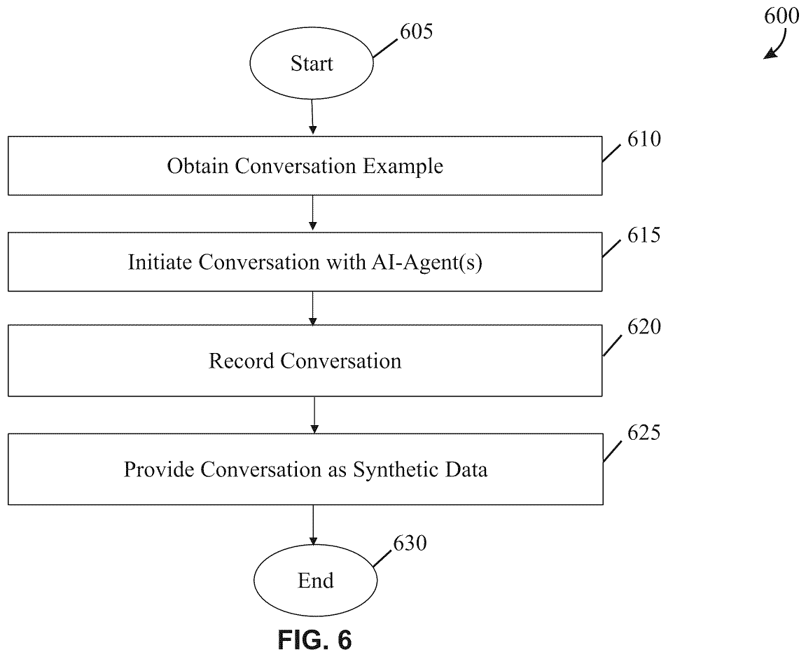

FIG. 6 illustrates an example simplified procedure for generating synthetic data for multi-agent AI applications, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, etc.) may obtain, via a first agent executed by the device, a conversation example for use by the first agent. In one implementation, the first agent obtains the conversation example from a multi-vector retriever.

At step 615, as detailed above, the first agent may initiate, based on the conversation example, a conversation with one or more artificial intelligence agents. In some implementations, the one or more artificial intelligence agents use a large language model (LLM) to converse with the first agent. In further implementations, the one or more artificial intelligence agents are part of an agentic artificial intelligence system.

At step 620, the first agent may record the conversation, as described in greater detail above.

At step 625, as detailed above, the first agent may provide the conversation as synthetic data to train or test an artificial intelligence model. In some instances, the device may also make a data quality assessment of the conversation, prior to providing it as synthetic data to train or test the artificial intelligence model. In one implementation, the device may do so by using an LLM to assess a measure of groundedness, relevance, or hallucination with respect to an answer provided by the one or more artificial intelligence agents in the conversation. In a further implementation, the device may make the data quality assessment using Monte Carlo Tree Search (MCTS) to assess a series of steps taken by the one or more artificial intelligence agents during the conversation. In some instances, the one or more artificial intelligence agents comprise a plurality of artificial intelligence agents that cooperate to perform the series of steps. In some cases, the device may also obtain feedback from a user interface regarding the conversation.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for generating synthetic data for multi-agent AI applications, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device that executes a first agent, a conversation example for use by the first agent;
initiating, by the first agent and based on the conversation example, a conversation with one or more artificial intelligence agents;
recording, by the first agent, the conversation; and
providing, by the device, the conversation as synthetic data to train or test an artificial intelligence model.

2. The method as in claim 1, wherein the first agent acts as a simulated user during the conversation.

3. The method as in claim 1, wherein the one or more artificial intelligence agents use a large language model (LLM) to converse with the first agent.

4. The method as in claim 1, wherein the one or more artificial intelligence agents are part of an agentic artificial intelligence system.

5. The method as in claim 1, further comprising:
making a data quality assessment of the conversation, prior to providing it as synthetic data to train or test the artificial intelligence model.

6. The method as in claim 5, wherein making the data quality assessment comprises:
using a large language model to assess a measure of groundedness, relevance, or hallucination with respect to an answer provided by the one or more artificial intelligence agents in the conversation.

7. The method as in claim 5, wherein making the data quality assessment comprises:
using Monte Carlo Tree Search (MCTS) to assess a series of steps taken by the one or more artificial intelligence agents during the conversation.

8. The method as in claim 7, wherein the one or more artificial intelligence agents comprise a plurality of artificial intelligence agents that cooperate to perform the series of steps.

9. The method as in claim 1, wherein the first agent obtains the conversation example from a multi-vector retriever.

10. The method as in claim 1, further comprising:
obtaining, by the device, feedback from a user interface regarding the conversation.

11. An apparatus, comprising:
one or more network interfaces;
a processor coupled to the one or more network interfaces and configured to execute one or more processes; and
a memory configured to store a process that is executable by the processor, the process when executed configured to:
obtain, via a first agent executed by the apparatus, a conversation example for use by the first agent;
initiate, by the first agent and based on the conversation example, a conversation with one or more artificial intelligence agents;
record, by the first agent, the conversation; and
provide the conversation as synthetic data to train or test an artificial intelligence model.

12. The apparatus as in claim 11, wherein the first agent acts as a simulated user during the conversation.

13. The apparatus as in claim 11, wherein the one or more artificial intelligence agents use a large language model (LLM) to converse with the first agent.

14. The apparatus as in claim 11, wherein the one or more artificial intelligence agents are part of an agentic artificial intelligence system.

15. The apparatus as in claim 11, wherein the process when executed is further configured to:
make a data quality assessment of the conversation, prior to providing it as synthetic data to train or test the artificial intelligence model.

16. The apparatus as in claim 15, wherein the apparatus makes the data quality assessment by:
using a large language model to assess a measure of groundedness, relevance, or hallucination with respect to an answer provided by the one or more artificial intelligence agents in the conversation.

17. The apparatus as in claim 15, wherein the apparatus makes the data quality assessment by:
using Monte Carlo Tree Search (MCTS) to assess a series of steps taken by the one or more artificial intelligence agents during the conversation.

18. The apparatus as in claim 17, wherein the one or more artificial intelligence agents comprise a plurality of artificial intelligence agents that cooperate to perform the series of steps.

19. The apparatus as in claim 11, wherein the first agent obtains the conversation example from a multi-vector retriever.

20. A tangible, non-transitory, computer-readable medium storing program instructions that cause a device that executes a first agent to execute a process comprising:
obtaining, by the device that executes the first agent, a conversation example for use by the first agent;
initiating, by the first agent and based on the conversation example, a conversation with one or more artificial intelligence agents;
recording, by the first agent, the conversation; and
providing, by the device, the conversation as synthetic data to train or test an artificial intelligence model.
